(19) United States
(12) Patent Application Publication
(10) Pub. No.: US 2009/0090742 A1
(43) Pub. Date: Apr. 9, 2009

(54) DISPENSING SYSTEM WITH INTERACTIVE MEDIA MODULE FOR DISPENSING CONCENTRATED MATERIALS

(75) Inventors: R. Bruce Yacko, Toledo, OH (US); Edward L. Mueller, Toledo, OH (US); Jeffrey C. Gayer, Sylvania, OH (US); Luke Stonis, Columbus, OH (US); Gary E. Myers, New Albany, OH (US); Tim C. Rothwell, Dublin, OH (US); Robert J. Hayes, Lewis Center, OH (US)

Correspondence Address: MACMILLAN SOBANSKI & TODD, LLC, ONE MARITIME PLAZA FIFTH FLOOR, 720 WATER STREET, TOLEDO, OH, 43604-1619, US

(73) Assignee: IDISPENSE, LLC, Toledo, OH (US)

(21) Appl. No.: 12/334,044

(22) Filed: Dec. 12, 2008

Related U.S. Application Data
(63) Continuation-in-part of application No. 12/210,746, filed on Sep. 15, 2008.
(60) Provisional application No. 60/993,578, filed on Sep. 13, 2007.
(60) Provisional application No. 61/061,677, filed on Jun. 16, 2008.

(51) Int. Cl. B67D 5/08

(52) U.S. Cl. 222/28; 222/25; 222/52

(57) ABSTRACT

A dispensing system has a source container for dispensing fluid concentrate into receiving containers, and a control module connected to the source container to control dispensing of the fluid concentrate from the source container. An interactive media module is configured to provide communication between the dispensing system and a user. The interactive media module has a menu of options and being capable of responding to commands by the user. The interactive media module is connected to the control module to provide input to the control module.

### CROSS-REFERENCE TO RELATED APPLICATIONS

This application is a Continuation-In-Part of pending patent application Ser. No. 12/210,746, filed Sep. 15, 2008, entitled “System and Apparatus for Dispensing Concentrated Materials”. application Ser. No. 12/210,746 is entitled to the benefit of provisional patent application Ser. No. 60/993,578 filed Sep. 13, 2007 and provisional patent application Ser. No. 61/061,677 filed Jun. 16, 2008. All of the above are incorporated herein in their entirety.

### TECHNICAL FIELD

This invention relates to a mechanism and method for dispensing concentrates into receiving containers, and for providing interaction with users of the system.

### BACKGROUND OF THE INVENTION

Cleaning and disinfectant solutions and other chemical compositions can be dispensed from receiving containers, such as spray bottles. Typically, a flow of diluent, such as water, is supplied with a small amount of concentrate, such as soap or other chemical concentrate. The mixture is then delivered to a receiving container, such as a hand held spray bottle. Typically, the cleaning mixture is used by janitors or other personnel to clean or disinfect facilities. Often personnel require instructions and training in cleaning procedures.

### SUMMARY OF THE INVENTION

According to this invention there is provided a dispensing system having a source container for dispensing fluid concentrate into receiving containers, and a control module connected to the source container to control dispensing of the fluid concentrate from the source container. An interactive media module is configured to provide communication between the dispensing system and a user. The interactive media module has a menu of options and being capable of responding to commands by the user. The interactive media module is connected to the control module to provide input to the control module.

According to this invention there is also provided a dispensing system having a source container for dispensing fluid concentrate into receiving containers, a detector configured to recognize the presence of a user of the dispensing system, and an interactive media module configured to provide communication between the dispensing system and the user. A control module is connected to the source container to control dispensing of the fluid concentrate from the source container. The control module is connected to the detector to receive input regarding the detection of a user. The interactive media module is connected to the control module to provide input to the control module, and the control module is configured to communicate with the user when the presence of the user is detected by the detector.

Various advantages of this invention will become apparent to those skilled in the art from the following detailed description of the preferred embodiment, when read in light of the accompanying drawings.

### BRIEF DESCRIPTION OF THE DRAWINGS

FIG. 1 is a schematic view in elevation of a concentrate dispensing system.

FIG. 2 is a schematic view of the concentrate dispensing system of FIG. 1, showing a display module and a user interacting with the system.

### DETAILED DESCRIPTION OF THE INVENTION

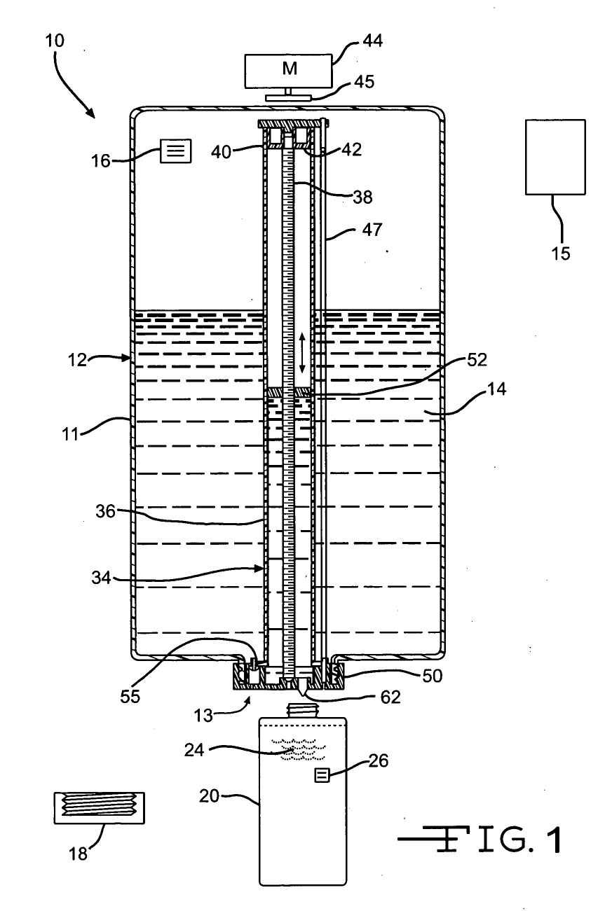

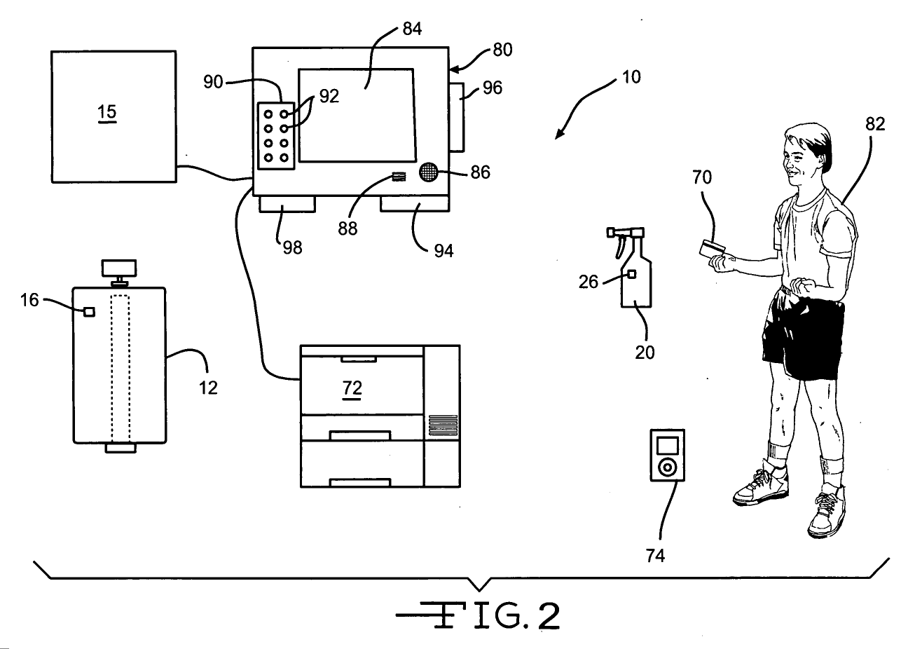

As shown in FIG. 1, the system for dispensing concentrated materials, indicated generally at 10, includes a source container 12 having a fluid-tight vessel 11 for holding the fluid concentrate 14. The source container 12 optionally includes machine-readable indicia, such as an RFID label 16, to indicate to a control module, such as controller 15, the content or composition of the concentrate 14. In other embodiments, there is no machine-readable indicia. The source container can be of many different configurations, but includes the fluid-tight vessel 11 configured to hold the fluid concentrate. Any number of concentrated fluids can be dispensed, such as, for example, concentrated soap, concentrated disinfectants, and concentrated food. A receiving container 20 is positionable beneath the source container 12 to receive the concentrate 14. In one embodiment, the receiving container is filled with diluent 24, such as water, before a small amount of the concentrate 14 is added. The dispensing system 10 includes a source of diluent, not shown, for supplying the appropriate diluent to the receiving container. The receiving container 20 optionally includes machine-readable indicia, such as an RFID label 26, to indicate to the controller 15, via a scanner or reader 44, shown in FIG. 2, data about the receiving container 20. The reader 44 can determine the size and nature of the receiving container 20, as well as other data. An appropriate receiving container top, not shown, with a spray handle, is typically associated with the receiving container 20. Other types of receiving containers, such as mop buckets, can be used. It is to be understood that there are many different types of source containers and dispensing configurations that can be used, and the source container can be different from that which is shown in FIG. 1.

The source container includes a discharge opening generally indicated at 13. This opening 13 optionally can be configured with a threads to receive a removable, threaded cap 18 during shipping and storage of the source container 12.

Positioned within the source container 12 is piston pump 34. The piston pump 34 is configured to withdraw the concentrate 14 from the source container vessel 11 and then dispense the concentrate in a controlled manner through an exit valve 62 in the discharge opening 13, and into the receiving container 20. The piston pump 34 includes a chamber or temporary reservoir 36 for receiving and dispensing concentrate, a plunger or piston shaft 38, and a piston head 52. The temporary reservoir 36 serves to hold fluid concentrate 14 as needed during the process of dispensing the fluid concentrate. The piston shaft 38 can be any suitable length. The piston shaft 38 can be operated by any suitable means, as will be explained below. In one embodiment the piston pump 34 is a syringe pump.

The piston head 52 is connected to the piston shaft 38 and is mounted for axial movement through the temporary reservoir 36. The movement of the piston head 52 through the temporary reservoir 36 can be accomplished in any suitable manner. In the embodiment shown in FIG. 1, the piston head 52 is mounted with a threaded connection to the piston shaft 38, which is a rotatable threaded shaft. Rotation of the shaft 38 causes the piston head 52 to move vertically up or down within the temporary reservoir. Downward movement of the piston head 52 causes the concentrate 14 within the temporary reservoir 36 of the piston pump 34 to be moved downwardly, through the one-way exit valve 62 and into the receiving container 20. Movement upward causes the temporary reservoir 36 to be filled by withdrawing concentrate 14 from the surrounding vessel 11 of the source container 12.

As shown in FIG. 1, the shaft 38 has a top end 40 at which there is a rotatably mounted hub 42, which is configured to hold magnets, not shown. Positioned in close proximity to the hub 42 is a stepper motor 44 connected to a rotatable motor magnet 45. The stepper motor 44 is configured to rotate the rotatable motor magnet 45 in discrete, measured rotational increments in response to signals from the controller 15. The stepper motor 44 and rotatable magnet 45 are shown as being outside the source container 12. It is to be understood that in other embodiments the rotatable magnet 45 can be positioned within the source container 12. The rotatable magnet 45 is aligned with the hub 42 so that rotation of the rotatable magnet 45 will cause a corresponding rotation of the hub 42, and therefore a rotation of the threaded shaft 38. Rotation of the shaft 38 in turn causes movement of the piston head 52 axially within the temporary reservoir. It is to be understood that other means besides a stepper motor 44 can be used for rotating the rotatable magnet 45. Also, other mechanisms beside rotating magnets, such as for example, a vacuum system, can be used to move the piston head 52 up and down within the temporary reservoir 36.

Positioned at the bottom of the piston pump 34 is a piston mounting cap 50. The piston cap 50 is provided with threads to enable the cap 50 and piston pump 34 to be threaded onto the opening 13 of the source container 12 in a fluid-tight connection after removal of the shipping cap 18. The cap 50 includes a mounting for the piston pump 34 and for the exit valve 62, and a seat for the vent tube 47.

The one-way exit valve 62 can be any valve suitable for controlling the flow of fluid concentrate from the temporary reservoir to the receiving containers. In the illustrated embodiment, a one-way duckbill valve is used. Other valves can be used. The valve need not be a one-way valve, but a one-way valve gives the advantage avoiding the inspiration of air during the filling of the temporary reservoir 36 when the piston head 52 is drawn up. Although a single valve 62 is shown, one or more valves controlling the flow of fluid concentrate 14 from the temporary reservoir 38 to the receiving containers 20 can be used.

The flow of fluid concentrate 14 between the vessel 11 and the temporary reservoir 36 is controlled by one or more inlet valves 55. The inlet valve 55 can be an umbrella valve, or any other suitable valve. It is advantageously a one-way valve to prevent reintroduction of the fluid concentrate into the source container vessel 11 during downward pumping of the piston 34.

In typical operation, the stepper motor 44 is first operated to drive the piston head 52 to the bottom of the temporary reservoir 36 of the piston pump 34. Then the piston head 52 is moved upward, drawing fluid concentrate 14 through the inlet valve 55 into the temporary reservoir 36. In one embodiment of operation, the receiving container is filled with diluent, such as water, before the addition of a small amount of the fluid concentrate. When a discharge of concentrate is desired, the stepper motor 44 moves the piston head 52 incrementally downward, forcing the desired amount of concentrate to flow downward through the one-way exit valve 62 and into the receiving container 20. Once all of the concentrate 14 in the temporary reservoir 36 is discharged into a multiplicity of receiving containers 20, the stepper motor 44 is operated to raise the piston head 52 again, thereby refilling the temporary reservoir 36 of the piston pump 34 with additional concentrate from the vessel 11.

It is to be understood that after the source container 12 is filled by the supplier of the concentrate material, the source container can be shipped with the pump 34 positioned within the source container, or in the alternative can be shipped with the pump accompanying the source container.

If the pump is shipped outside of the source container, the customer using the dispensing apparatus removes the shipping cap 18 and installs the pump 34 before using the apparatus. Further, the pump can be part of a dispensing apparatus for dispensing fluid concentrate from a plurality of source containers into receiving containers, where the source containers have a uniform opening suitable for receiving a closure, such as the shipping bottle cap 18. The apparatus includes a connection (e.g. threaded connection) that enables the apparatus to connect to the opening of any one of the plurality of source containers. The apparatus includes a pump configured to be positioned into any one of the source containers and configured to withdraw a portion of the fluid concentrate from the source container and to store the portion of fluid concentrate in a temporary reservoir. The apparatus also can be configured to dispense a metered amount of the fluid concentrate from the temporary reservoir to dispense the fluid concentrate into receiving containers.

It is to be understood that in any of the embodiments, the stepper motor 44 can be controlled by the controller 15, and the controller can be configured to keep track of the amount of concentrate dispensed, and to prevent unauthorized discharging from, tampering with, or filling of the source container 12.

As shown in FIG. 2, the system 10 for dispensing fluid concentrate includes an interactive media module 80. The user 82 can interact with the interactive media module 80 to provide input to the controller 15. The interactive media module 80 optionally includes a display screen 84 for visual communication to the user 82. The interactive media module 80 also has an optional speaker 86 for auditory communication with the user 82. A microphone 88 can also be provided. A headset, not shown, can also be provided with the system for communication with the user. The interactive media module 80 also includes an optional input device 90. The input device 90 can include an array of buttons 92, as shown in FIG. 2, and can also include keyboards, touch screens, switches, voice recognition equipment, or any other alternative interactive elements. The interactive media module 80 can optionally include its own controller 98, but this is not necessary. The input sources feeding data into the interactive media module 80 can include the RFID label 26 on the receiving container 20, RFID label 16 on the source container 12, or the user ID 70 being held by the user 82. Other forms of input sources can also be used.

The interactive media module 80 is connected to the controller 15 by any suitable means, such as hard wire, or electronic transmission. This affords the user 82 the ability to transmit information to, and receive information from, the controller 15.

The interactive media module 80 includes a reader 94 that is configured to read data from various data sources. The reader can be configured to read the ID 70 of the user 82 when the user 82 approaches the interactive media module 80. The controller 15 can be configured to automatically check authorization of the user 82, or it can be set up to require an initial contact by way of data input by the user 82, such as, for example, by requiring the user 82 to enter a PIN number. The term “authorization of the user” can optionally include assessing the frequency and type of specific operations authorized for the user.

In another embodiment, the reader is configured to receive data from the ID 70 when the user 82 swipes the card in the reader 94. The reader can also be configured to read the RFID label 26 on the receiving container 20 and provide this information to the controller 15. The controller 15 can be configured to respond to the data from the reader 94 and make determinations as to authorization of prospective users. In one embodiment, the controller 15 takes into account the frequency of use by the user 82, the size of the receiving container 20, and the scope of the authority of the user 82. Further, the controller 15 can be configured to assure a proper match between the receiving container 20 and the source container 12. In one embodiment the user 82 has a hand-held data device 74 that can communicate with the interactive media module 80. The controller 15 has the capability to determine the authority of the user to dispense a specific fluid concentrate. The controller 15 is capable of receiving authorization protocols, which the controller will enforce via disabling the dispensing system 10 when appropriate. Additional security measures may be incorporated.

When activated, the controller 15 may offer communication prompts to the user 82 allowing the user 82 to choose the format of communication from a selection of languages, graphics, symbols, icons or any other suitable means. For example, the interactive media module 80, when detecting the presence of the user 82, can audibly ask the user 82 to select a language for communication. In another embodiment, the user's ID card 70 can include basic information about the user 82 such as a preferred language. It can be seen that the information transmitted between the controller 15 and the user 82 can take a number of forms. For example, the controller 15, through the display screen 84, speaker 86, microphone 88, input device 90 or other suitable means can facilitate interactive communication with the user 82 via audio, audio book, text, graphics, symbols, icons or any other suitable means.

The interactive media module 80 can also be configured to provide instructions to the user 82 regarding how to use the receiving container 20 once it is filled. For example, the information displayed on the screen 84 may include instructions to the user 82 as to how to perform the task of cleaning a specific area of a facility. The instructions could include step-by-step instructions for cleaning the specific area. The instructions can be simple or complex, and can be provided in text, icon form, video or other suitable forms. One benefit of the interactive media module 80 is to allow users unfamiliar with the cleaning procedures to perform the desired cleaning tasks. The interactive media module 80 can also tailor the instructions to be in the preferred language for the user 82. The ability of the user 82 to select a preferred language or communication medium allows a greater number of potential users to perform desired tasks. A benefit of the instructions provided by the interactive media module 80 is that users can perform desired tasks with a minimum amount of supervision. Also the efficiency of the work is greatly increased by providing accurate instructions.

The system 10 can be configured to provide instructions for the user 82 to completely fill or top off a partially filled receiving container 20. Such instructions could include measuring or detecting the amount of mixture already in the receiving container 20 as well as instructions for filling the bottle with additional diluent and additional concentrate. It is to be understood that in some cases the receiving container 20 will not require filling or topping off. In such cases the user 82 may only need instructions on use of the mixture and will not need instructions for filling or topping off the receiving container 20.

The controller 15 may have a memory capable of recording the information sent to and from the controller 15 via the interactive media module 80. Additionally, the information transmitted between the controller 15 and the user 82 can be transmitted to an alternative media output. For example, the information on the display screen could be sent by the controller 15 to a printer 72, or to portable media devices such as the hand held data device or instructional device 74, which can be any suitable media storage device, such as an Ipod. As a result, the controller 15 could supply the user 82 with portable hard copy or electronic maps, task lists, instructions, graphics or other data arrangements relating to tasks or training to be performed by the user 82. The supplied information could be specific to specific receiving containers.

The controller is programmable to allow the input and processing of additional data and programs. For example, the controller 15 can be provided with additional icons for display on the display screen 84, and can also be configured to receive data pertaining to cleaning or disinfecting additional areas of a facility. The controller can also be configured to receive information necessary to dispense additional fluid concentrates from additional source containers. The ability to customize the dispensing system 10 enables a high degree of flexibility for operation and use of the dispensing system 10. In one embodiment, the controller 15 is configured to automatically translate typed instructions from one language into another, e.g. English to Spanish.

In operation, when a user 82 comes within range of the reader 94, the interactive media module 80 can identify the user 82 via the ID 70. The interactive media module 80 may also be activated by sounds or movement within an area or by the presence of the receiving container 20, as detected by the RFID label 26. The interactive media module 80 can query the user 82 regarding a choice of interactive language (e.g. English, Spanish, etc.). The controller 15 and the interactive media module then afford the user the opportunity to select a task or information module from a menu of options. These options could include: commanding the system to refill a receiving container 20, providing instructions for a cleaning task, and providing information regarding specific user authorizations. For example, the options could include the cleaning of a cafeteria in a facility. The reader 94 reads the RFID label 26, which indicates the size of the container 20, the type of fluid concentrate to dispense and specific tasks appropriate to the specific container 20. Once the controller is assured of proper authorization, identification of the task to be performed and an appropriate matching of the receiving container with the source container, the controller 15 commands the source container 12 to dispense the fluid concentrate into the receiving container 20. It is to be understood that many of these steps are optional and need not be performed in every operation. Further, it is to be understood that the diluent can be placed in the receiving container prior to the dispensing of the fluid concentrate into the receiving container. In one embodiment, a source of diluent is provided with the dispensing system.

In one embodiment, the interactive media module 80 has a reader 94 that is configured to receive data from the user, and the controller is configured to determine authority to use the dispensing system based on the data from the reader. The data from the user could come from the ID card 70, from the RFID chip 26 on the receiving container 20, or any other source of information from the user 82. In another embodiment the data from the user can be used by the controller 15 to initiate communications by the interactive media module 80 describing tasks to be performed by the user 82, and listing the steps to be taken or the equipment or items necessary to perform the tasks. In another embodiment, the data from the user can be used by the controller 15 to initiate user training.

An optional feature is the use of a detector 96 that is configured to recognize the presence of a user of the dispensing system. The controller 15 is connected to the detector 96, and is configured to communicate with the user when the presence of the user is detected by the detector.

The dispensing system can be configured to determine if there is a match between the source container 12 and the receiving container 20. A match could be that they are both designed to receive the same chemicals, or that the receiving container is of the appropriate size or configuration for the fluid concentrate in the source container, or that the container is appropriate for a task. If a match is determined to be present then the dispensing system will allow dispensing of the fluid concentrate into the receiving container.

In another embodiment, the controller 15 is connected to controllers of other dispensing systems in order to coordinate a larger number of dispensing systems and tasks.

The portable instructional device 74 can be programmed with instructions for various cleaning tasks. The portable instructional device 74 can be activated by location-specific triggers or readers, not shown. Thus, for example, when the user 82 enters a specific room in the facility, the portable instruction device 74 is activated to display, receive or provide audible and/or visual instructions concerning the tasks to be performed in that room. The portable instructional device 74 can also be configured to record data in connection with the tasks performed. The portable instructional device 74 can include an interactive instructional headset.

It is to be understood that the dispensing system 10 can be configured with multiple source containers 12. In one embodiment, the dispensing system 10 includes instructions for selecting the appropriate source container where multiple source containers are present. Also the dispensing system 10 can include instructions for changing source containers, such as, for example, when a source container is depleted of concentrate.

The principle and mode of operation of this invention have been described in its preferred embodiments. However, it should be noted that this invention may be practiced otherwise than as specifically illustrated and described without departing from its scope.

What is claimed is:

1. A dispensing system comprising:
a source container for dispensing fluid concentrate into receiving containers;
a control module connected to the source container to control dispensing of the fluid concentrate from the source container; and
an interactive media module configured to provide communication between the dispensing system and a user, the interactive media module having a menu of options and being capable of responding to commands by the user, the interactive media module being connected to the control module to provide input to the control module.

2. The dispensing system of claim 1 wherein the interactive media module includes a display screen.

3. The dispensing system of claim 1 wherein the interactive media module is configured to prompt the user to choose a communication format that is one or more of keyboard, graphics, symbols, icons, text, and audible signals.

4. The dispensing system of claim 1 wherein the interactive media module is configured to receive communications from the user with the method of communication being in the form of one or more of buttons, audible commands, touch screen, and keyboard.

5. The dispensing system of claim 1 wherein the system has a reader configured to receive data from the user, and wherein the control module is configured to determine authority to use the dispensing system based on the data from the reader.

6. The dispensing system of claim 1 wherein the system has a reader configured to receive data from the user, and wherein the control module is configured to initiate user training.

7. The dispensing system of claim 1 wherein the control module is configured to determine authorization of the user.

8. The dispensing system of claim 1 wherein the system is configured to determine if the receiving container requires filling or topping off.

9. The dispensing system of claim 1 wherein the system has a reader configured to receive data from the receiving container, and wherein the control module is configured to perform one or more of the following:
determine tasks that can be performed with the receiving container;
provide instructions to the user for tasks that can be performed with the receiving container; and
provide instructions to the user pertaining to tasks that can be performed with the receiving container.

10. The dispensing system of claim 1 wherein the control module is configured to determine a communication language preferred by the user.

11. The dispensing system of claim 1 wherein the control module is configured to determine a match between the source container and the receiving container.

12. A dispensing system comprising:
a source container for dispensing fluid concentrate into receiving containers;
a detector configured to recognize the presence of a user of the dispensing system;
an interactive media module configured to provide communication between the dispensing system and the user; and
a control module connected to the source container to control dispensing of the fluid concentrate from the source container, the control module being connected to the detector to receive input regarding the detection of a user, the interactive media module being connected to the control module to provide input to the control module, and the control module being configured to communicate with the user when the presence of the user is detected by the detector.

13. The dispensing system of claim 12 wherein the control module is configured to request identification from the user when the presence of the user is detected by the detector.

14. The dispensing system of claim 12 wherein the interactive media module has a display screen, and wherein the control module is configured to turn on the display screen when the presence of the user is detected by the detector.

15. The dispensing system of claim 12 wherein the control module is configured to display a menu of options for the user.

16. The dispensing system of claim 12 wherein the control module is configured to request audible input from the user.
